(19) United States
(12) Patent Application Publication
(10) Pub. No.: US 2016/0363290 A1
(43) Pub. Date: Dec. 15, 2016

(54) LED OPTICAL MODULE

(71) Applicant: OZG Powersports, Inc., Santee, CA (US)

(72) Inventor: Gong Beiwen, Zhongshan City (CN)

(73) Assignee: OZG POWERSPORTS, INC., Santee, CA (US)

(21) Appl. No.: 14/738,696

(22) Filed: Jun. 12, 2015

(51) Int. Cl. F21V 13/04; F21V 17/06; F21V 5/04; F21V 17/16; F21K 99/00; F21V 7/00

(52) U.S. Cl. CPC F21V 13/04; F21K 9/54; F21V 7/0066; F21V 5/048; F21V 17/164; F21V 17/06; F21Y 2101/02

(57) ABSTRACT

An LED optical module has a reflecting cup, LED lamp and convex lens. The surface of the reflecting cup consists of the bottom half of the first reflecting cup's internal surface and the top half of the second reflecting cup's internal surface. The top and bottom sides of convex lens are all convex. For the optical module, the four focal points combine together and there is no disordering light output caused by the combination of the reflecting cup and the convex lens. The illumination intensity (Lux) is three times the amount of the existing products in the market.

### FIELD OF THE INVENTION

The present invention related to an LED optical module.

### BACKGROUND

Auto lights or searching lights are required to have a long lighting distance. Reflecting cups and convex lens are commonly applied into those products. As for the current auto lights or searching lights, those reflecting cups and convex lens are single side and the combination of the reflecting cup and convex lens will cause the disordering light and weak luminous output.

### SUMMARY OF THE INVENTION

In order to solve the current defect, the present invention provides the following solution:

The present invention is a LED optical module that includes a reflecting cup assembly, a LED lamp and one or more convex lenses. The surface of the reflecting cup assembly comprises a first reflecting cup's internal surface and a second reflecting cup's internal surface. The top and bottom surfaces of the one or more convex lenses are convex. Mounting buckles in the upper portion of the reflecting cup engage with mounting arms located along the rim of the one or more convex lenses to secure the lens(es) to the reflecting cup.

For the optical module, the four focal points combine together and there will be no disordering light output caused by the combination of reflecting cup and convex lens. The illumination intensity (Lux) is approximately three times the amount of the existing products in the market.

### BRIEF DESCRIPTION OF THE DRAWINGS

FIG. 1 shows an exploded perspective view of the LED optical module; and

FIG. 2 shows a cutaway view of the LED optical module.

### DETAILED DESCRIPTION

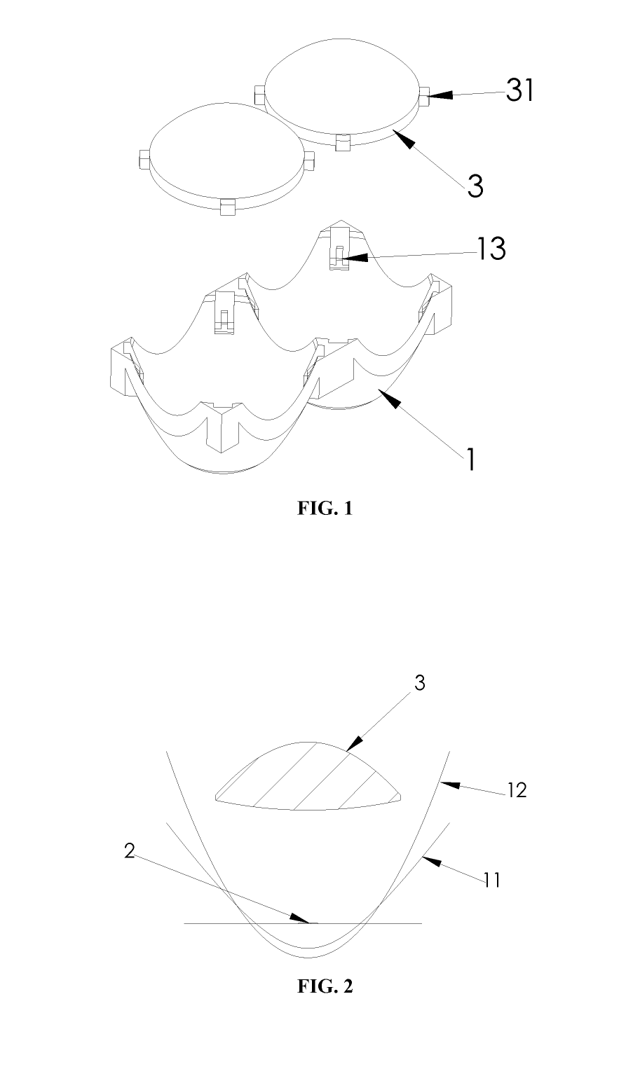

Based on FIGS. 1-2, below is the explanation for the detailed description of the present invention so that the advantage and feature of the present invention can be understood more easily by the technicians in this field, which will explicitly define the protection scope of the present invention.

As shown in FIGS. 1-2, the present invention is a LED optical module which includes reflecting cup assembly 1, LED lamp 2 and convex lens 3. The surface of the reflecting cup assembly 1 consists of the internal surface of the first reflecting cup 11 and the internal surface of the second reflecting cup 12.

In one embodiment, each of the cups has a different slope profile, wherein the first reflecting cup 11 has a wider angle to disperse light over a wider area in front of the cup 11, and the second reflecting cup 12 has a narrower angle to focus the beam more in front of the cup 12.

The top and bottom sides of convex lens are all convex. There is mounting buckle 13 in the upper end of reflecting cup that matches the mounting arm 31 located on the rim of the convex lens.

The advantage of the present invention is that the four focal points combine together and there will be no disordering light output caused by the combination of reflecting cup and convex lens. The illumination intensity (Lux) is three times the amount of the existing products in the market.

The above description is only a detailed application plan of the present invention, but the protection scope of this invention is not limited to this. Within the disclosed technical scope of the present invention, the change or replacement raised without creative labor by any technicians who are familiar with this field should be covered within the protection scope of the present invention. Therefore, the protection scope of the present invention should be subjected to the protection scope defined on the Claim of Patent Right.

I claim:

1. An LED optical module, comprising:
a) a reflecting cup assembly, comprising
i. a first reflecting cup; and
ii. a second reflecting cup;
b) at least one LED lamp positioned within the first reflecting cup and the second reflecting cup; and
c) one or more convex lenses,
wherein a top surface and a bottom surface of the one or more convex lenses are convex.

2. The LED optical module of claim 1, further comprising:
a) a plurality of mounting buckles on an upper end of the reflecting cup; and
b) a plurality of mounting arms protruding from a rim of the convex lens,
wherein the plurality of mounting buckles and the plurality of mounting arms are configured to engage one another.

3. The LED module of claim 1 wherein the first reflecting cup has a wider angle configured to disperse light over a wide area in front of the assembly, and the second reflecting cup has a narrower angle to focus the beam in front of the assembly.
